(19) United States
(12) Patent Application Publication
(10) Pub. No.: US 2011/0043319 A1
(43) Pub. Date: Feb. 24, 2011

(54) PULSE TRANSFORMER

(75) Inventor: Jörg BLANKE, Lemgo (DE)

Correspondence Address: HARNESS, DICKEY & PIERCE, P.L.C., P.O. BOX 828, BLOOMFIELD HILLS, MI, 48303, US

(73) Assignee: PHOENIX CONTACT GMBH & CO. KG, Blomberg (DE)

(21) Appl. No.: 12/855,389

(22) Filed: Aug. 12, 2010

(30) Foreign Application Priority Data
Aug. 14, 2009 (DE) 102009037340.3-24

(51) Int. Cl. H01F 27/28

(52) U.S. Cl. 336/220

(57) ABSTRACT

A pulse transformer having a primary core (1) with a primary winding (2), a first secondary core (3) with a first secondary winding (4) and a second secondary core (5) with a second secondary winding (6), wherein the primary core (1), the first secondary core (3) and the second secondary core (5) are connected to each other by way of a squirrel-cage winding (7). In accordance with the invention, a transformer current converter is cited that, as a doubler, provides an input signal at two outputs in such a manner that—with an equal number of turns on the first secondary winding (4) and the second secondary winding (6)—the same signal is available at both outputs.

### BACKGROUND OF THE INVENTION

1. Cross-Reference to Related Application

This application claims the benefit and priority of German Patent No. 10 2009 037 340.3-24 filed Aug. 14, 2009. The entire disclosure of the above application is incorporated herein by reference.

2. Technical Field

The invention relates to a pulse transformer having a primary core with a primary winding, a first secondary core with a first secondary winding and a second secondary core with a second secondary winding.

3. Discussion

Electronic components are known from interface technology, such as modular converters for measuring and control equipment and in particular isolation amplifiers. Isolation amplifiers of this kind can be used for the electrical isolation, implementation, amplification and/or filtering of standard and norm signals and adaptation of analog signals. Isolation amplifiers are frequently isolated electrically from one another in the input, output and/or feed circuit. As the result of being isolated, interference among the sensor and actuator circuits is prevented because the ground loops created by grounding the various electrical circuits are interrupted.

Electrical isolation is achieved, for example, by inductive passive components that possess the property of transmitting electrical energy. A passive element known from the prior art is the transformer, for example, that makes it possible to step up or step down alternating voltages. A transformer that is not used to transmit energy but for the analog transmission of information is known in the prior art as a pulse transformer. A pulse transformer of this kind can be used for the transmission of energy and/or of signals, wherein both aforementioned electronic components function in accordance with the same principle of an inductive component. The electronic components of isolation amplifiers, specifically of the pulse transformer, are frequently mounted on printed circuit boards (PCBs), wherein the PCB is arranged in an insulating material housing and equipped with screw, plug or spring terminal equipment. Such insulating material housings can be snapped onto top-hat rails in accordance with EN 50022 and can thus be installed in switch cabinets.

The pulse transformers known from the prior art normally have a core and several windings on the core. The core, for example, is designed as a magnetic core of a soft magnetic material, for example ferrite, while the winding is preferably made from an insulated wire. The output current, or the output voltage respectively, is determined by the winding ratio in those pulse transformers that are normally terminated at high resistance, or in pulse transformers designed as current converters that are normally short-circuited in the output. The pulse transformers known from the prior art frequently have multiple secondary windings so that the output voltage is applied at all secondary windings independently of whether the output is under load or not. In this case, each individual output current varies depending on the load and is independent of the load at the adjacent output.

A current converter, or pulse transformer, is known from DE 10 2005 041 131 in which two or more cores are connected by means of a squirrel-cage winding or coupling winding to form a pulse transformer or current converter. In this instance, two or more windings are wound onto the secondary core. As with the other pulse transformers known from the prior art and previously mentioned as examples, the output currents of the secondary windings of the pulse transformer from DE 10 2005 041 131 are distributed unequally depending on the output loads. Such a division of output loads that cannot be calculated makes such pulse transformers or current converters unusable for many fields of application.

### SUMMARY OF THE INVENTION

An object of the invention is to provide a pulse transformer that has at least two outputs reliably providing the same current.

Preferably, the object is achieved by a pulse transformer having a primary core with a primary winding, a first secondary core with a first secondary winding and a second secondary core with a second secondary winding, wherein the primary core, the first secondary core and the second secondary core are connected to each other by a squirrel-cage winding.

In accordance with an aspect of this invention, a pulse transformer, or current converter, is cited that, in its function as doubler, provides an input signal at two outputs in such a manner that—with the same number of turns on the first secondary winding and the second secondary winding—the same signal is available at both outputs. Surprisingly, it was discovered that the pulse transformer in accordance with the invention makes it possible to provide the same current in an especially simple way at the two outputs, wherein the currents are not divided unequally because of different loads for example. Because both secondary windings are in one series circuit, the current in both secondary windings is the same with the same number of turns. With a different number of turns in the secondary windings, the output currents of the secondary windings behave according to the ratio of the number of turns in the secondary windings.

Within the scope of the present invention, input and output are understood to mean the primary winding or the first secondary winding and/or the second secondary winding respectively. An input voltage is accordingly present at the primary winding, for example, while an output voltage is present at a secondary winding.

The primary core, the first secondary core and/or the second secondary core can be configured as any type of core for any type of inductive component—in collaboration with a winding. Preferably the primary core, the first secondary core and/or the second secondary core has a magnetic core of a soft magnetic material, but quite particularly preferably a ferrite core. The primary winding, the first secondary winding, the second secondary winding and/or the squirrel-cage winding are/is preferably configured as an electrical conductor, such as a wire, but quite particularly preferably as an insulated wire. In principle, any current whatever can be applied at the primary winding, the first secondary winding and/or the second secondary winding. Preferably, however, the pulse transformer is operated with a current of 0 to 5, 10, 20, 50 and/or 100 mA at the primary winding and/or at a secondary winding.

As mentioned initially, the squirrel-cage winding can be configured in any way. Quite particularly preferably, the squirrel-cage winding is self-contained, comprising a closed winding, for example. It is further preferred that the squirrel-cage winding has one, two, five or ten windings.

In principle, the first secondary winding and/or the second secondary winding can have any number of turns. In accordance with a particularly preferred embodiment of the invention, the number of turns in the first secondary winding is the same as the number of turns in the second secondary winding. As the result of a configuration of this kind, the currents in the two secondary windings, that is, in the first secondary winding and in the second secondary winding, are equally high, thus they are not divided unequally in the case of an unequal load at the first secondary winding and at the second secondary winding, but are the same.

In accordance with a further preferred embodiment of the invention, the primary core, the first secondary core and the second secondary core each has a center hole, wherein the primary winding, the first secondary winding and the second secondary winding are positioned by their respective center hole and the squirrel-cage winding is positioned by its respective center hole. Configured in this way, the primary core, the first secondary core and the second secondary core each forms an inductive component wherein the primary core, the first secondary core and the second secondary core preferably comprise a magnetic core of a soft magnetic material, and the primary winding, the first secondary winding and the second secondary winding together with the squirrel-cage winding are preferably formed from insulated wire. The primary winding, the first secondary winding and the second secondary winding and/or the squirrel-cage winding can be dimensioned with a view to the anticipated voltages, currents and number of turns.

In principle, the transformer can be produced as any type of electrical component using any type of manufacturing process known from the prior art. In accordance with a particularly preferred embodiment of the invention, the intention is for the pulse transformer to comprise a substrate for provision on a PCB, the substrate comprises a conductor, and the primary core, the first secondary core and/or the second secondary core can be attached to the substrate in such a manner that the conductor comprises the squirrel-cage winding. As a result, an especially space-saving transformer of low height can be produced that can be installed particularly easily on PCBs known from the prior art.

The pulse transformer in accordance with the preferred embodiment of the invention is furthermore quite especially preferably configured such that the requirements for clearance and creepage distances in accordance with the standards to ensure intrinsic safety, also known as EX standards, are met. These include standards EN 60079-11 or EN 60079-0, meaning that the primary core with the primary winding, the first secondary core with the first secondary winding, the second secondary core with the second secondary winding and the squirrel-cage winding are dimensioned and positioned on the substrate to comply with EX standards. Similarly it is preferable that the conductor is dimensioned to match the anticipated currents and/or voltages in the squirrel-cage winding. It is further preferable that the conductor is provided within the substrate so that the substrate forms the insulation for the conductor. The substrate can also be configured as a PCB known from the prior art to position the primary core and the secondary cores.

In accordance with a further preferred embodiment of the invention, a second conductor is provided on the substrate and/or on the PCB, and the conductor is connected to the second conductor to form the squirrel-cage winding. Quite particularly preferably, a closed squirrel-cage winding is prepared as the result of such a configuration. Providing a second conductor on the substrate and/or on the PCB makes a particularly simple configuration for the squirrel-cage winding practicable.

In principle, the primary winding, the secondary winding, the second secondary winding and/or the squirrel-cage winding can be electrically contacted using any means known from the prior art. However, in accordance with a further preferred embodiment of the invention, the substrate has contact surfaces for contacting the PCB and/or for contacting the primary winding, the first secondary winding, the second secondary winding and/or the squirrel-cage winding. The contact surfaces may, for example, be made of metal so that electrically conductive connections can be produced between the PCB, the conductor, the primary winding, the first secondary winding , the second secondary winding, the squirrel-cage winding and/or external contacts by soldering, bonding or other means known from the prior art. Through such contact surfaces, an electrically conductive contact to an activating circuit for the transformer can be produced in an especially simple way, for example.

In accordance with another preferred embodiment of the invention, the substrate contains arms to locate the primary core, the first secondary core and/or the second secondary core, wherein the conductor is provided in the arm. It is further preferred that the substrate has two oppositely located arms, the primary core being arranged on the first arm and the first secondary core and the second secondary core being arranged on the second arm. Quite particularly preferably, the first arm and the second arm are spaced apart from one another. It is further preferred that the conductor is surrounded by at least 0.5 mm of insulating material, by the substrate for example. Configured in this way, the requirements of the EX standards can be satisfied. Furthermore, by arranging the primary winding, the first secondary winding and the second secondary winding appropriately, the spacings, clearance and creepage distances necessary to conform with the EX standards for safe electrical separation, by positioning on oppositely aligned arms are ensured. Quite particularly preferred, the squirrel-cage winding is divided equally on both sides of the oppositely arranged arms which results in improved pulse of the inductive components so configured.

It is further preferred that the first secondary winding and the second secondary winding, which are preferably arranged on one of the oppositely arranged arms, are isolated from each other by insulation. Such insulation can be, for example, a circular disc of a non-conducting material, wherein the insulation preferably has a center hole so that the insulation can be arranged on the arm in the same way as the first secondary core and the second secondary core.

In accordance with another preferred embodiment of the invention, the substrate is designed as a planar substrate and/or the substrate can be attached to the PCB using SMD technology. It is further preferred that the substrate has a suction surface so that a vacuum suction device can pick up the substrate, transport it, position it above the PCB and deposit it. By using SMD technology, the pulse transformer can be of a space-saving design and employed even in restricted spaces.

In accordance with another preferred embodiment of the invention, the squirrel-cage winding has at least one winding. It is further preferred that the primary core, the first secondary core and/or the second secondary core are implemented as annular cores or as rectangular cores. The use of a pulse transformer in accordance with the invention as the current converter is quite particularly preferred.

In accordance with another preferred embodiment, the pulse transformer comprises at least three secondary cores, wherein each secondary core has a respective secondary winding, and the primary core and the secondary cores are connected to each other by way of the squirrel-cage winding. It is consequently preferable that the pulse transformer, in addition to the first secondary core and the second secondary core, comprises at least one additional secondary core with a respective additional secondary winding, wherein the additional secondary cores as well as the primary core, the first secondary core and the second secondary core are similarly connected to each other by way of the squirrel-cage winding. Additional embodiments for the additional secondary cores or additional secondary windings, respectively, are derived by analogy with what has been implemented previously.

### BRIEF DESCRIPTION OF THE DRAWINGS

The invention is explained in more detail hereinafter with reference to the appended drawings of a preferred embodiment, in which:

FIG. 1 shows an inventive pulse transformer in accordance with a preferred embodiment of the invention in a schematic view,

FIG. 2 shows the equivalent circuit diagram of the pulse transformer in accordance with the preferred embodiment of the invention,

FIG. 3 shows the inventive pulse transformer on a substrate in accordance with the preferred embodiment of the invention in a plan view.

### DESCRIPTION OF THE PREFERRED EMBODIMENTS

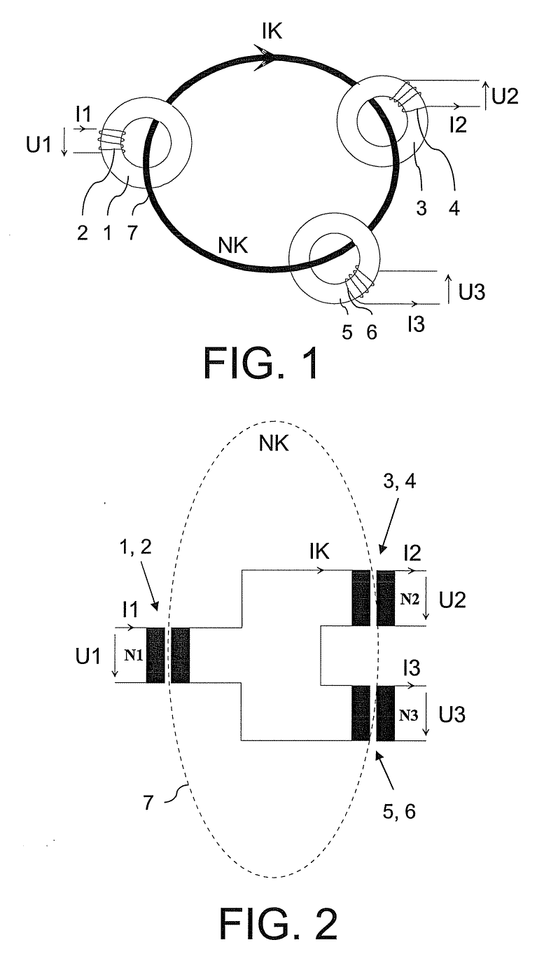

FIGS. 1-3 show a pulse transformer having a primary core with a primary winding 2, a first secondary core 3 with a first secondary winding 4, and a second secondary core 5 with a second secondary winding 6. The primary core 1, the first secondary core 3 and the second secondary core 5 are connected to each other through a squirrel-cage winding 7.

A pulse transformer, or current converter, of this kind is used in order to transmit energy or signals separated electrically. The number of windings N1, N2, N3 determines he output current I2, I3 or the output voltage U2, U3, respectively, depending on the input current I1 or the input voltage U1. Current converters are usually in the output, short-circuited on the secondary winding 4, 6, while voltage transformers are terminated in the output at high resistance.

When using the pulse transformer as a current converter, as was explained previously, the secondary windings 4, 6 operate in a short circuit so that a current I1 impressed upon the primary side can flow in the secondary circuits I2, I3. If, therefore, a current I1 is impressed upon the primary side into the current converter, it is stepped up into the squirrel-cage winding 7 using the transmission ratio of N1 to NK.

As can likewise be seen from the equivalent circuit diagram for the pulse transformer under the invention in FIG. 2, this stepped-up current IK flows as the primary current through the additional sub-transformers, the secondary cores 3, 5 with the secondary windings 4, 6, and is stepped down again at the transmission ratio of NK to N2, or N3. With the same number of turns in the windings N2 and N3, the same currents I2, I3 flow in both secondary windings 4, 6 because the primary current, that is, the short-circuit current IK of the sub-transformers, is equally high.

Surprisingly it was discovered that, with the same number of turns in the windings N2 and N3, the same currents I2 or I3 flow in the first secondary winding 4 and in the second secondary winding 6. The pulse transformer, or current converter, in accordance with the invention enables the electrical separation of an input signal U1, I1 onto two output signals U2, I2, U3, I3 such that the same current flows at both outputs, and the currents I2, I3 are not split unequally when the windings N2 and N3 have same the number of turns.

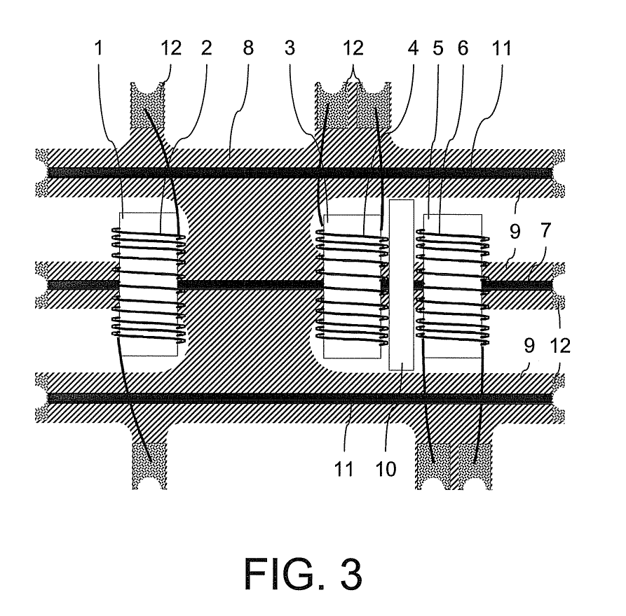

FIG. 3 shows an SMD-technique transformer integratable into a PCB in accordance with the invention, wherein the primary core 1, the first secondary core 3 and the second secondary core 5 have a magnetic core of a soft magnetic material, wherein the respective magnetic cores have a central hole, not shown, by which the primary winding 2, the first secondary winding 4 or the second secondary winding 6 and a squirrel-cage winding 7 designed as a conductor are guided. The squirrel-cage winding 7 designed as a conductor is arranged in a substrate 8.

As can be seen further from FIG. 3, the substrate 8 has arms 9 to position the primary core 2, the first secondary core 3 and the second secondary core 5, where the conductor is arranged in the arm 9. The primary core 2 is located on a first arm 9 and the first secondary core 3 and the second secondary core 5 are located on a second arm 9 spaced apart from each other. Because of this kind of spacing, that is, suitably large clearance and creepage distances for safe electrical separation of the primary winding 2 and the secondary windings 4, 6, the spacing necessary for achieving the EX standards can be realized.

Furthermore, insulation 10 is provided between the first secondary winding 4 and the second secondary winding 6, wherein the insulation 10 is made from an insulating material.

The substrate 8 also has a second conductor 11, where the second conductor 11 and/or a conductor provided on the PCB, not shown, can be used to create the closed squirrel-cage winding 7.

Metal contact surfaces 12 are provided for making electrical contact with the PCB and the primary winding 2, the first secondary winding 4, the second secondary winding 6, the squirrel-cage winding 7 and the second conductor 11; said contacts can be connected in a manner known from the prior art, for example by soldering, using appropriate PCB contacts.

The transformer in accordance with the invention makes it practicable to provide in a particularly simple and compact manner two identical, secondary-side currents I2, I3 which are the same irrespective of the load, when there is the same number of turns in windings N2 and N3.

What is claimed is:

1. A pulse transformer comprising a primary core (1) with a primary winding (2), a first secondary core (3) with a first secondary winding (4) and a second secondary core (5) with a second secondary winding (6) wherein the primary core (1), the first secondary core (3) and the second secondary core (5) are connected to each other by way of a squirrel-cage winding (7).

2. The pulse transformer of claim 1, wherein the squirrel-cage winding (7) is self-contained.

3. The pulse transformer of claim 1, wherein the number of turns on the first secondary winding (4) is the same as the number of turns on the second secondary winding (6).

4. The pulse transformer of claim 1, wherein the primary core (1), the first secondary core (3) and the second secondary core (5) each has a center hole, the primary winding (2), the first secondary winding (4) and the second secondary winding (6) are positioned by their center holes and the squirrel-cage winding (7) is positioned by the its center hole.

5. The pulse transformer of claim 1, wherein the transformer has a substrate (8) to be provided on a PCB, the substrate (8) has a conductor and the primary core (1), the first secondary core (3) and/or the second secondary core (5) can be attached to the substrate in such manner that the conductor forms the squirrel-cage winding (7).

6. The pulse transformer of claim 5, wherein a second conductor (11) is provided on the substrate and/or on the PCB and the conductor is connected to the second conductor (11) to form the squirrel-cage winding (7).

7. The pulse transformer of claim 5, wherein the substrate (8) has contact surfaces (12) for making electrical contact with the PCB and/or making electrical contact with the primary winding (2), the first secondary winding (4), the second secondary winding (6) and/or the squirrel-cage winding (7).

8. The pulse transformer of claim 5, wherein the substrate (8) has arms (9) to position the primary core (1), the first secondary core (3) and/or the second secondary core (5) and the conductor is provided in the arm (9).

9. The pulse transformer of claim 8, wherein the substrate (8) has two oppositely located arms (9), the primary core (1) is arranged on the first arm (9) and the first secondary core (3) and the second secondary core (5) are arranged on the second arm (9).

10. The pulse transformer of claim 9, wherein the first arm (9) and the second arm (9) are located spaced apart from one another.

11. The pulse transformer of claim 1, wherein the first secondary winding (4) and the second secondary winding (6) are isolated from each other by insulation (10).

12. The pulse transformer of claim 5, wherein the substrate (8) is a planar substrate and/or the substrate (8) can be attached to the PCB using SMD technology.

13. The pulse transformer of claim 1, wherein the squirrel-cage winding (7) has at least one winding.

14. The pulse transformer of claim 1, wherein the primary core (1), the first secondary core (3) and/or the second secondary core (5) are respectively designed as annular cores or as rectangular cores.

15. The pulse transformer of claim 1, with at least three secondary cores (3, 5), wherein each secondary core (3, 5) has a respective secondary winding (4, 6), and the primary core (1) and the secondary cores (3, 5) are connected to each other by way of the squirrel-cage winding (7).
